(19) United States
(12) Patent Application Publication
(10) Pub. No.: US 2020/0256120 A1
(43) Pub. Date: Aug. 13, 2020

(54) BUILDING ENVELOPE SURFACE ELEMENT WITH CONTROLLABLE SHADING

(71) Applicant: Flachglas Entwicklungs GmbH, Grimma (DE)

(72) Inventor: Lothar WONDRACZEK, Jena (DE)

(21) Appl. No.: 16/651,960

(22) PCT Filed: Sep. 28, 2018
(86) PCT No.: PCT/DE2018/100820

§ 371 Date: Mar. 27, 2020

(30) Foreign Application Priority Data
Sep. 29, 2017 (DE) 10 2017 122 812.8

(51) Int. Cl. E06B 9/24; E04B 2/88; E06B 3/67; G02F 1/166; G02F 1/1685; B03C 1/30; B03C 1/28; B03C 1/033

(52) U.S. Cl. CPC E06B 9/24; E04B 2/88; E06B 3/6722; G02F 1/166; G02F 1/1685; G02F 2001/1678; B03C 1/288; B03C 1/0332; B03C 1/0335; E06B 2009/2417; B03C 1/30

(57) ABSTRACT

The invention is directed to a building envelope surface element with controllable shading. The object of finding a novel possibility for controllable shading of building envelope surface elements which permits a control without electric area electrodes and has short switching times is met according to the invention in that the fluid flows through capillary channels via a fluid circuit so as to be circulated by means of a pump, in that magnetic particles are incorporated in the fluid in the form of a suspension, and in that at least one particle collector is arranged to be controllable outside of the capillary channels in order to concentrate the magnetic particles incorporated in the fluid in defined pipe portions of the particle collector by magnetic attraction and to decouple the magnetic particles transiently from the fluid circuit.

### PRIORITY CLAIM

The present application is a National Phase entry of PCT Application No. PCT/DE2018/100820, filed Sep. 18, 2018, which claims priority from German Patent Application 10 2017 122 812.8, filed Sep. 29, 2017, the disclosures of which are hereby incorporated by reference herein in their entirety.

### FIELD OF THE INVENTION

The invention is directed to a building envelope surface element with controllable shading for use in exterior building facades as glass exterior wall element, glass roof element and window element. It is particularly suitable for sun shading but is also suitable for solar thermal energy generation.

### BACKGROUND OF THE INVENTION

Large-area glass facade elements play an indispensable role in modern architecture, where it is increasingly important to facilitate the interaction between the interior of a building and its environment, to rely on a high transparency of the material to visible (Vis) and infrared (IR) light and to achieve a thermal compensation function with a superior long-term stability under a variety of use conditions. Glass facades provide visual comfort and a sense of wellbeing but also facilitate productivity in commercial buildings. However, in connection with the use of glass, a dedicated control of heat transport with regard to both heating scenarios and cooling scenarios as well as seasonally dependent shading for reducing glare or enhancing privacy are particularly important. The first requirement is typically met through the use of complex multi-layer coatings which allow a selective reflectivity in the visible and infrared spectral region and, for example, offer a low emissivity (low E) or a high level of sun protection. Such coatings are often combined with the high insulating capacity of double glazing, triple glazing or even vacuum glazing. Shading or, generally, providing interiors with adjustable levels of daylight is a secondary function which adds considerable complexity to the glass elements. Conventional devices such as blinds, shades or curtains provide for static optical characteristics and offer only limited options for adaptive responses to variable weather conditions. Similarly, bothersome glare is generally reduced at the expense of usable daylight so that artificial light must possibly be used to compensate in spite of ample available exterior light. The development of systems which enable dynamic control of the natural flow of light through glass facades and which, at the same time, lead to a sharp reduction in CO₂ emissions from all-glass buildings (estimated at around 40% of European energy requirement) is the current focus of the so-called smart window industry.

A variety of innovative glazing techniques are known from the art for customized shading and transparency control which take into account the sun protection function as well as reducing the radiated heat loss from the building. These include various concepts for switchable windows in which the optical properties can be manipulated by an external trigger. Electrically controllable glazing primarily relies on the use of chromogenic AC voltage-operated suspended particle devices (SPDs) or liquid crystal devices (LCDs). All of these require electric conductivity on the glass surface, which is usually obtained through transparent conductive oxide layers (TCO layers).

In SPD technology, a thin laminate layer of (preferably rod-shaped) particles is suspended in a liquid (fluid) and held between two glass plates or plastic plates or attached to one layer. With no external voltage, the particles are in a randomly oriented state. When voltage is applied, the particles align in a defined manner, for example, and let light pass. The orientation of the particles can be varied by varying the voltage such that the tint of the glazing and the proportion of transmitted light can be adjusted. SPDs can be manually or automatically adjusted to precisely control the amount of light, glare or heat passing through and to reduce the use of air conditioning in the summer and heating in the winter. Control of SPDs can be carried out through a variety of media, e.g., automatic photosensors, motion detectors, mobile telephone applications, integration in smart buildings and vehicle systems, turning knobs and light switches, etc. For real-world applications requiring cooperation with further auxiliary components such as secondary coatings, electrolytes, dyes, sealing layers and adhesives, the end solutions are extremely complex. Apart from the high costs, other problems arise in TCO films or systems with low-E films which interfere with thickness requirements, insulation functions or—specifically for the building sector—with weight limits and with process compatibility for the extremely wide variety of window geometries, standardized frames or holders.

Specifically, the limitations of electric devices typically include:
(1) limiting to a thin layer of immobilized liquid having the switching function, which reduces the expected lifetime of the device;
(2) prolonged relaxation times usually lasting several minutes between opaque and non-tinted states;
(3) the requirement for a continuous power supply in the transparent state with frequently encountered power consumptions of 5-20 Wm⁻²; and
(4) the reduced long-term UV stability and high costs resulting above all from the TCOs that are used.

Tin-doped indium oxide (ITO), as the most commonly used TCO film, actually causes substantial problems owing to the provision of indium oxide at acceptable prices. Accordingly, in spite of the availability of alternative transparent conductors such as, e.g., poly(3,4-ethylenedioxythiopene) (PEDOT) or carbon nanotube (CNT) films, current smart window requirements cannot be met. While PEDOT suffers from poor environmental stability and insufficient tinting, CNT films are not yet available for low-cost, large surface area applications.

There are essentially two different operating concepts known in the art with respect to electrically controlled window elements (so-called smart windows) based on SPD technologies: voltage-controlled with an active fluid, and circulation-controlled with a passive fluid. A basic technological construction of a building envelope surface element is described, for example, in DE 10 2014 012 559 A1, which discloses a construction of two sheet-like glass elements at least one of which has a plurality of longitudinally-directed grooves which are covered by the other surface element and accordingly form capillary channels. The capillary channels lead into a collecting channel, respectively, at both end areas. One of the collecting channels forms the forward feed and the other forms the return feed when connected to a fluid circuit, thus allowing the fluid to circulate through the capillary channels uniformly and in the same direction. An oil is disclosed as fluid, infrared-sensitive particles being suspended therein for receiving thermal radiation from the surroundings of the building surface element so that particularly solar heat radiation from the outside as well as radiation from the inside of the building can be absorbed and supplied to a closed heating and heat storage circuit.

A further device is known from US 2009/0308376 A1 for absorbing solar energy and simultaneously controlling the admission of light through a window element into the building interior. A system is described which comprises two frames which carry plates of transparent material between which is introduced a colored solution from an external reservoir. The two frames are connected to one another through a flexible membrane so that they can be pressed together to make the window transparent or pushed away from each other to interpose the colored solution therebetween and make the window element gradually less transparent or opaque. The flowing in and flowing out of the colored solution is controlled through the level of vacuum within the external reservoir with the colored solution. In the opaque or semi-transparent state of the window element, the liquid is heated by solar energy and guided through a circulation pump to a heat exchanger.

Further, US 2014/0204450 A1 describes a capillary fluidic thermoptic processor having a substrate with a plurality of channels through which a fluid circulates. The liquid is selected to absorb and store thermal energy, and the capillary fluidic panel is suitably adapted to convert the thermal energy into usable energy or to condition the energy for adjusting to an optical wavelength bandpass of the panel. Carbon-containing nanoparticles or particles comprising zinc sulfide, zinc oxide, cadmium selenide, indium phosphide, gold, silver, iron oxide, titanium dioxide, silicon and silicon dioxide are suitable for storing energy in the liquid but, at the same time, also have low retardation for the diffusion of energy. A glass panel with a grid of channels in which the stored energy is converted through a thermoelectric generator is provided for the capillary fluidic panel.

### SUMMARY OF THE INVENTION

It is the object of the invention to find a novel possibility for controllable shading of building envelope surface elements such as glass exterior wall elements, glass roof elements or window elements which permits a control without electric area electrodes and has short switching times. As an expanded object, the fluid should have a high heat absorbing ability which is likewise controllable.

In a building envelope surface element with controllable shading containing a capillary glass element in which a plurality of parallel capillary channels are formed and the capillary channels are connected on one side of the capillary glass element to a first collecting channel and on a second side to a second collecting channel, the first collecting channel and the second collecting channel being integrated in a fluid circuit so that a fluid can flow through the capillary channels via the collecting channels, the above-stated object is met according to the invention in that the fluid flows through the capillary channels via the fluid circuit so as to be circulated by means of a pump, in that magnetic particles are incorporated in the fluid in the form of a suspension, and in that at least one particle collector is arranged to be controllable in the fluid circuit outside of the capillary channels in order to concentrate the magnetic particles incorporated in the fluid in defined pipe portions of the particle collector by magnetic attraction and to decouple the magnetic particles transiently from the fluid circuit.

The particle collector can advantageously be activated by switching the orientation of permanent magnets relative to defined pipe portions or, alternatively, by switching on electromagnets.

The defined pipe portions of the particle collector are advisably formed two-dimensionally or three-dimensionally as pipe elbows or tube elbows so as to save space. They can preferably be arranged in meander-shape or can be helix-shaped, spiral-shaped or can have twofold arrangements formed thereof.

Clear liquids such as aqueous alcohol solutions, particularly aqueous alkanol solutions, paraffin oils or silicone oils can advantageously be used as fluid.

The magnetic particles which are incorporated in the fluid as suspension are advantageously made of iron, iron oxide, particularly magnetite, or dark-colored rare earth metals or rare earth metal oxides. They preferably have an order of magnitude that is greater than or equal to one fourth of the wavelength of a radiation incident on the capillary glass element that is preferably to be absorbed by the particles.

The capillary glass element carrying the capillary channels advisably comprises two plates which are connected to one another. The plurality of parallel capillary channels is formed between opposing surfaces through surface structuring in at least one of the plates and is covered by the other plate. The capillary glass element is preferably assembled from a structured plate and a non-structured cover plate, and the two plates are connected to one another by means of an overlaminate adhesive layer with adapted refractive index.

The above-stated object is further met by a composite window in that at least one building envelope surface element according to one of the preceding embodiments is used, and the building envelope surface element preferably forms the portion of the composite window facing a building interior or is applied in a building facade system.

The invention is based on the fundamental consideration that electrically operated SPD-based window elements have stationary fluid layers but have area electrodes which are expensive, constantly conduct current for the transparent state of the window, require additional layers on the substrate surface and are difficult to produce in technological respects or are an unnecessarily costly burden. On the other hand, circulating fluids which flow through the window element and vary the particle density in order to change transparency and heat absorption have the disadvantage that they may respond slowly to changes in external circumstances or take too long to switch between states.

The invention resolves these conflicting effects in that particles with magnetic properties which generate an extensive shading effect are introduced in a circulated suspension. The switching effect for transparency of the window element is achieved by magnetically filtering out the particles outside of the window glass surface in a magnetically controlled particle collector. Suspensions of magnetic metals such as iron, iron oxide, particularly magnetite, or rare earth metals or rare earth metal oxides in transparent clear liquids such as water, aqueous solutions of alcohols or, in particular, alkanols, paraffin oils or silicone oils are advantageous, and the particles, preferably comprising iron (II, III) oxide, iron or a dark-colored rare earth metal or rare earth metal oxide, are concentrated or accumulated in spatially limited, defined pipe portions through the action of permanent magnets or electromagnets when a transparent state is to be achieved. As an added effect, the particles which are pumped in suspension in a fluid circuit have a high heat absorption ability and are suitable for reducing the heat absorption of the building envelope surface element by dissipating heat input.

With the invention, it is possible to realize building envelope surface elements such as glass exterior wall elements, glass roof elements or window elements with controllable shading and absorption of light and heat radiation which permits a control without electric area electrodes and has a high heat absorption of the fluid and short switching times for changing transparency and heat absorption.

### BRIEF DESCRIPTION OF THE DRAWINGS

The invention will be described more fully in the following with reference to embodiment examples and diagrams. The drawings show:

FIG. 1a a basic view of the invention as sectional diagram through a capillary channel of the building envelope surface element with a passive fluid and magnetic particles in a pumped fluid circuit shown in the switched off state on the left-hand side and in the switched on state on the right-hand side;

FIG. 1b a schematic top view of the OFF operating state and ON operating state of the SPD window area of the building envelope surface element;

FIG. 2a a schematic view of the basic construction of a building envelope surface element with fluid circuit;

FIG. 2b a schematic view of a preferred construction of the device according to the invention with two glass elements in which the grooves of the first glass element are closed by the second glass element;

FIG. 3a a schematic view of a particle collector in an advantageous construction with meander-shaped pipe portions and a set of uniformly aligned permanent magnets in the switched on state (ON);

FIG. 3b a schematic view of the particle collector in the advisable configuration of FIG. 3a in the switched off state (OFF) through permanent magnets which are rotated in parallel position relative to the pipe portions;

FIG. 3c a graph illustrating the time behavior of the particle collector between the states of FIG. 3a and FIG. 3b;

FIG. 3d a schematic view of a second embodiment of the particle collector with spiral-shaped tubing and electromagnets which are arranged so as to be uniformly distributed and which are switched to the ON state by current flow;

FIG. 3e a schematic view of a further embodiment of the particle collector with helical tubing and electromagnets which are arranged so as to be uniformly distributed and which are switched to the ON state by current flow;

FIG. 4 schematic diagrams and graphs illustrating the optical transmission of the device according to the invention for different particle concentrations during the opening of the device according to the invention;

FIG. 5 a schematic illustration of the optical transmissivity and reflectivity in a laminated area (A) and a capillary channel area (B);

FIG. 6 a diagram of the energy density of solar energy available on the SPD window area of the building envelope surface element and the reflected and absorbed amounts of energy;

FIG. 7a a diagram illustrating the output yielded through a 300×210 mm fluidic SPD under artificial illumination with a radiant flux density of 280 W m⁻², input temperature of 20° C. and a flow rate of 50 mL min⁻¹ for three different particle concentrations, quantified by model calculation (left-hand side) and experimentally (right-hand side);

FIG. 7b a diagram illustrating the output yielded through a 300×210 mm² fluidic SPD under artificial illumination with a radiant flux density of 280 W m⁻², input temperature of 20° C. and a flow rate of 50 mL min⁻¹ for three different particle concentrations, quantified by model calculation (left-hand side) and experimentally (right-hand side);

FIG. 8 a diagram showing experimental results of the quantified output for which the incoming radiant flux density was varied at constant flow rate of 50 mL min⁻¹ and particle concentration of 0.25 vol %;

FIG. 9 a case of use for a smart window for inside shading and simultaneous solar energy absorption and dissipation.

### DETAILED DESCRIPTION

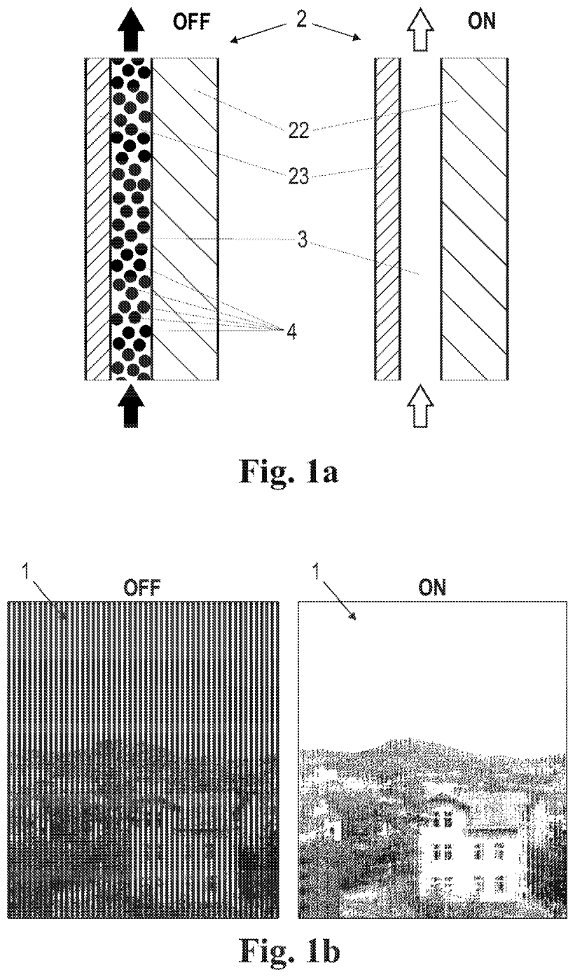

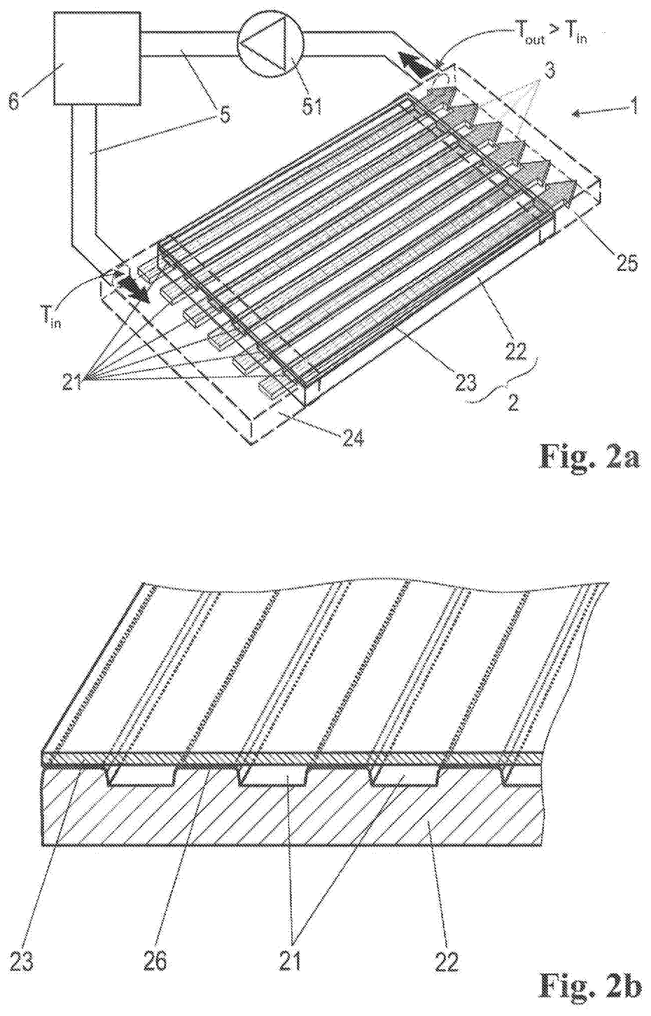

The basic operating principle of the novel device based on SPD technology is shown in FIG. 1. A sectional view of the building envelope surface element 1 is shown in the upper diagram a) at left. The building envelope surface element 1 has fluid 3 which flows between two transparent plates 22, 23 of glass or plastic and which is formed as magnetoactive liquid with magnetic or magnetized particles 4 which cause a shading of the incident radiation and a high absorption, particularly for infrared spectral components. Iron particles, iron oxide particles, particularly magnetite particles, and rare earth metal particles are used as magnetic particles 4 with the additionally desired high absorption capacity. The particle sizes are selected between 0.01 μm and 10 μm and are preferably between 0.1 μm and 5 μm. They are preferably nanoparticles whose order of magnitude is governed by the wavelengths of the radiation to be primarily absorbed, preferably of visible light from 400 nm up to IR radiation, and approximately corresponds to or is greater than one fourth of the mean wavelength of the radiation to be absorbed. The particles 4 advisably have a surface which is modified in such a way that an improved dispersancy is achieved in aqueous alkanol solutions. This can preferably take place through measures for electrical charging. The light shading effect and light absorption effect of the particles 4 take place for fluid 3 circulating in a circuit 5 (shown only in FIG. 2a) as well as for a stationary fluid 3. However, fluid circulation is the precondition for the controllability of transmission and absorption of the building envelope surface element 1.

The diagram on the left-hand side in FIG. 1a shows the OFF state of the building envelope surface element 1 in which no controlling action is exerted on the particles 4. On the right-hand side of FIG. 1a, which shows the ON state of the building envelope surface element 1, the particles 4 are filtered out of the flowing fluid 3 through a magnetically operating particle collector 6 inside of a pumped circuit 5 of the fluid 3 (shown only in FIG. 2a) and are concentrated in the circuit 5 in the region of the particle collector 6 and, depending on the strength of the magnetic field in the particle collector 6, are partially or completely filtered out and retained.

The amount of magnetic particles 4 circulating when controlled in the above-described manner, preferably magnetite nanoparticles in orders of magnitude of between 100 nm and 800 nm, is qualitatively depicted in FIG. 1b) only schematically for the above-mentioned OFF and ON states, since the capillary channels 21 in at least one of the plates 2 cannot be depicted in actual dimensions and spacing.

The construction of a building envelope surface element 1 according to the invention is shown schematically in FIG. 2 with an enlarged view of the SPD (suspended particle device) and illustrates the desired absorption of energy through the fluid 3 when circulating through the capillary channels 21 of a capillary glass element 2 which are in a parallel longitudinally directed arrangement. In this example, the capillary glass element 2 advisably comprises a structured plate 22, in which the capillary channels 21 are introduced as strip-shaped grooves, and a non-structured cover plate 23 by which the capillary channels 21 of the structured plate 22 are covered.

The absorption of energy of incident light inside the fluid 3 which is transparent in itself —without the particles 4—takes place solely through the particles 4 which have a high absorption coefficient due to the dark coloration typical of their material. In order to realize the flow of fluid, the capillary channels 21 are guided together at their opposite ends in a collecting channel 24 as fluid inlet of the capillary glass element 2 and in a collecting channel 25 as fluid outlet and are integrated into the circuit 5 in which the fluid 3 is circulated by means of a pump 51. Accordingly, the energy absorbed by the particles 4 can be conducted off and supplied to a heating or cooling system, not shown here.

FIG. 2b shows the detailed construction of the capillary glass element 2 comprising structured plate 22 and non-structured cover plate 23 with an adhesive layer 26 laminated on the webs between the capillary channels 21. The mean distance between adjacent capillary channels 21 is advantageously selected in the range of from 1 mm to 10 mm, preferably between 3 and 6 mm, and should be proportionately approximately 0.5 to 1.0 times the width of the capillary channel. The height of the capillary channels is in the range of from 0.1 to 3 mm, preferably between 0.5 and 1.5 mm, depending on the viscosity of the fluid 3, the particle size and the structuring process for producing the capillary channels 21 and in the following examples amounts to 1 mm.

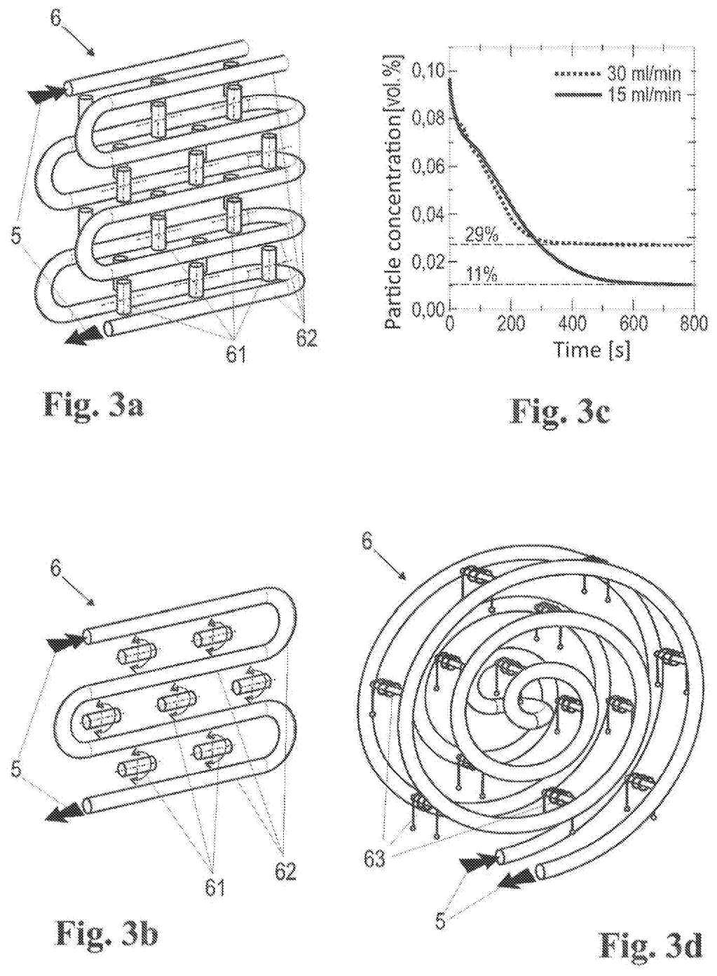

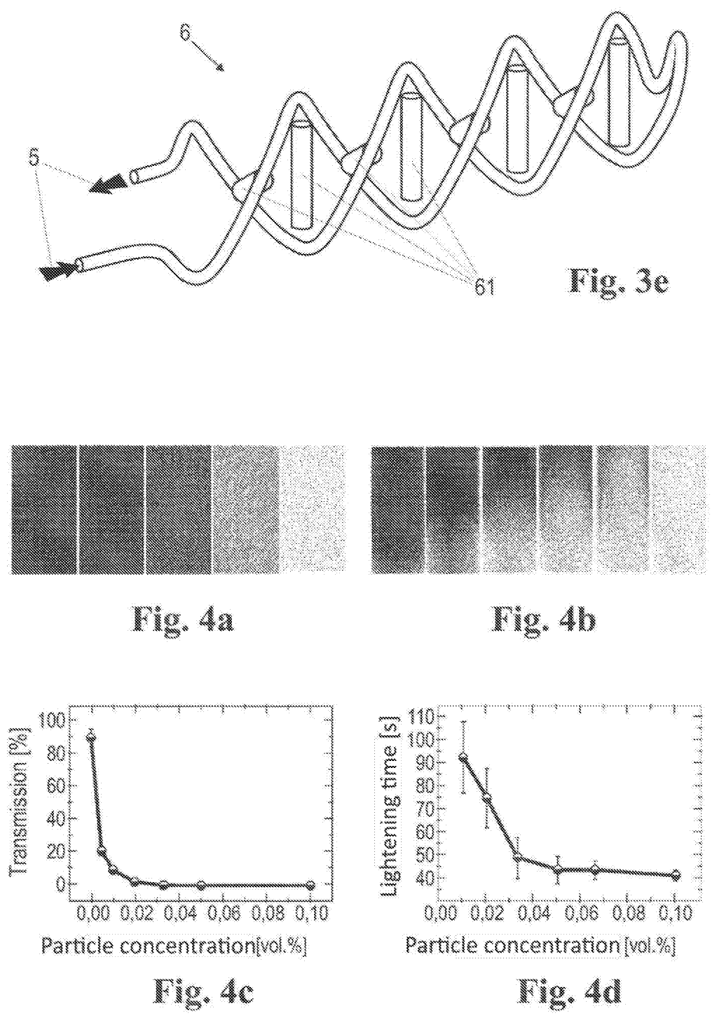

FIG. 3 shows preferred embodiments of the particle collector 6 which provides for the so-called SPD switching of transparency and absorption. The switching of the SPD state of the building envelope surface element 1 involves varying the particle concentration of particles 4 in the fluid 3 inside the capillary glass element 2. In order to prevent contamination and to ensure a homogeneous flow through the entire system without air bubbles, the separating process must be carried out linearly, i.e., without interrupting the fluid flow. Therefore, a system for particle collection and re-suspension is carried out in a particle collector 6 as is shown in different constructional variants in FIG. 3a, FIG. 3b, FIG. 3d and FIG. 3e.

FIG. 3a shows a preferred design of the particle collector 6 which was obtained through computer simulation of the particle field interaction and was derived from magnet configuration and field intensity from laboratory experiments. It comprises defined pipe portions 62 which have a series of meander-shaped tube turns or pipe turns for placement of twenty uniformly spaced permanent magnets 61. The fastening angles for the permanent magnets 61 can be rotated by an angle of 90° automatically for controlled attraction or release of particles. The case where the magnet alignment of permanent magnets 61 is released is shown in FIG. 3b in another configuration of the defined pipe portions 62 with a planar arrangement of the meander-shaped tube turns or pipe turns in which the permanent magnets 61 are oriented parallel to the defined pipe portions 62 through which fluid circulates. As a result of this configuration, when the permanent magnets 61 are switched to the perpendicular ON state, the particle concentration at the outlet 64 of the particle collector 6 follows a decay function as is shown in FIG. 3c depending on the flow velocity. Interestingly, the flow rate quantity does not primarily influence the decay time. It acts instead on the total quantity of particles 4 that can possibly be collected while the fluid 3 passes through the particle collector 6. The collector parameterization and the further optimization must therefore be carried out with respect to the desired flow rate (adapted to the thermal requirements of the system), the magnetic field strength (primarily determined by the use of permanent magnets or electromagnets), the collector dimensions, the concentration of particles 4 in the fluid 3 and the desired degree of shading of the building envelope surface element 1. By controlling the flow rate of particles 4 through the particle collector 6, an adaptable shading can be achieved.

FIG. 3d and FIG. 3e show arrangements of defined pipe portions 62 equivalent to the above-described constructions of the particle collector 6. In these constructional variants, the pipe portions 62 are outfitted with electromagnets 63. In contrast to the permanent magnets 61 utilized in the previous examples, electromagnets 63 do not require any mechanical switching but rather are activated or passivated by switching the current flow on or off.

In FIG. 3d, a spiral shape is selected as structure of the defined pipe portions 62, and the schematically shown electromagnets 63 are arranged so as to be spaced apart uniformly between parallel portions of the pipe spirals guided in parallel. The ON state of the particle collector 6 configured in this way is activated by switching on the coil current of the electromagnets 63 and can be controlled for different magnetic field strengths.

FIG. 3e shows a further embodiment form of the defined pipe portions 62 of the particle collector 6 in which the tubular shape follows a helical line. This shape is preferably formed as a double helix structure, and the electromagnets 63 are arranged so as to be uniformly spaced apart along the central axis of the helix so as to be progressively rotated relative to one another by the same angle.

Optionally, the permanent magnets 61 and electromagnets 63 may be exchanged, as required, in all of the above-described arrangements of the particle collector 6.

The modulation of transparency and shading inside of the capillary glass element 2 of the building envelope surface element 1 will be described in the following referring to FIGS. 4a-d.

As reference, optical data are first collected directly for suspensions with different particle concentrations and during the clear state of the fluid 3. The opacity of the initial suspensions (FIG. 4a) results from the light scattering and absorption of the randomly distributed particles 4. Dynamic light scattering (DLS) confirms the mean particle diameter of less than 200 nm of the particles 4 selected in this example. The corresponding transmission data are shown in FIG. 4b, which gives a variability within 100-8% over the observed range of particle concentrations for a geometric path length of 10 mm.

Using permanent magnets 61 or electromagnets 63, particles 4 can be “extracted” from the suspension (fluid 3) so that the optical transmissivity of the fluid 3 is increased. FIG. 4c shows a typical example of this in which the particles 4 were precipitated out of the fluid 3 by applying a permanent magnet 61 with a field strength of 0.4 T to the bottom of a cell at a distance of 1.7 mm. In this case, the full transparency of the fluid 3 is produced after approximately four minutes. Time-resolved studies of this lightening effect were conducted using a full HD camera recording. Selected snapshots are shown in FIG. 4c. The captured images can then be subjected to a grayscale analysis in which the clear fluid 3 is taken as “white reference”. The lightening time (switching time) is defined as the time at which 90% of the initial transmissivity has been reached. Corresponding data are indicated in FIG. 4d. A decrease of the lightening time to approximately 45 s was observed with increasing particle concentration of particles 4 up to a content of 0.05 vol %, above which no further improvement was observed.

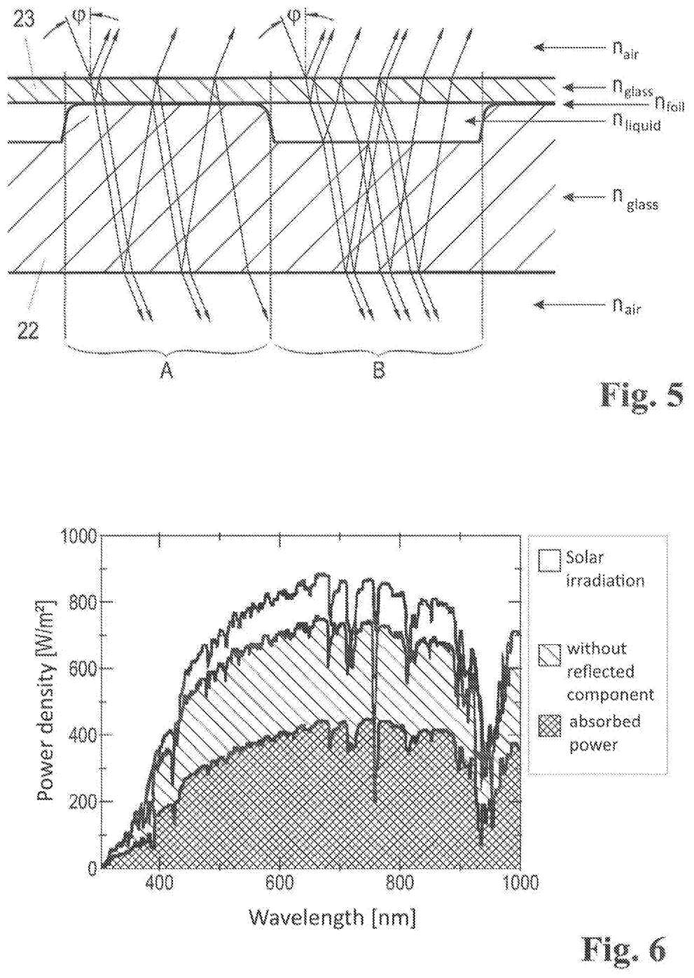

The transmission and energy absorption will be described in the following referring to FIG. 5 and FIG. 6.

In order to evaluate the optical characteristics, the geometry of the present SPD, i.e., the layer construction of the capillary glass element 2 of the building envelope surface element 1, is considered, as is shown in FIG. 5, as a side-by-side combination of two stacks A and B in the area of a capillary channel 21 and in the area of a web between two capillary channels 21 and is approximated by a model. Stacks A and B are modeled as a medium with finite thickness and as a semi-infinite medium and are uniformly distributed over the capillary glass element 2. Stack A corresponds to the portion of the structured plate 22 (refractive index n_{glass}), a thin adhesive layer 26 (refractive index n_{foil}) and the cover plate 23 (n_{glass}). Stack B comprises the glass of structured plate 22, the fluidic layer (fluid 3 with n_{fluid}) inside capillary channel 21 and the glass of the cover plate 23. The individual components are differentiated by their respective refractive index and their spectral absorption coefficients.

In FIG. 6, the optical transmissivity and the reflectivity are shown on the plane of the SPD of the building envelope surface element 1. The graph shows the solar radiation spectrum on air mass 1.5 and the corresponding proportions of energy that are reflected and absorbed by the system. Through computer-generated data, the spectral angle-dependent reflection and extinction of the individual portions of the SPD can be shown using a fluid 3 with a particle concentration of particles 4 of 0.05 vol %. The glasses used and an EVA foil preferably used as cover plate 23 have a high transparency over the visible and near infrared spectral region so that the amount of energy absorbed in stack A of FIG. 5 is negligible. In this case, the incoming radiation is completely transmitted or reflected at the layer interfaces. In stack B of FIG. 5, a significant absorption is induced through the fluid layer of fluid 3. The imaginary portion of the refractive index k of stack B is estimated through k=(α·λ)/(4π) with the absorption coefficient a obtained through spectral photometry and wavelength λ.

The reflection data and absorption data can subsequently be averaged over all incident angles φ and applied to a reference solar radiation spectrum at air mass 1.5 in order to quantify the amount of reflected and absorbed solar energy on the plane of the SPD. In the diagram in FIG. 6, the difference between the white and shaded areas of the spectral energy curves shows the amount of energy that is reflected back into the atmosphere. The cross-hatched area corresponds to the effective amount of energy absorbed in stack B of FIG. 5. Integrated data are compiled in the following Table 1. Since each of the stacks A and B occupies exactly half of the system, the effective energy absorption of the system per surface unit corresponds to one half of the values indicated in Table 1.

TABLE 1
Relative energy absorption E_{eff} in stack B and on the SPD
plane for various particle concentrations c.

| C (vol %) | E_{eff}, Stack B | E_{eff}, SPD |
|---|---|---|
| 0.05 | 50.37% | 25.19% |
| 0.10 | 71.95% | 35.98% |
| 0.25 | 84.79% | 42.40% |

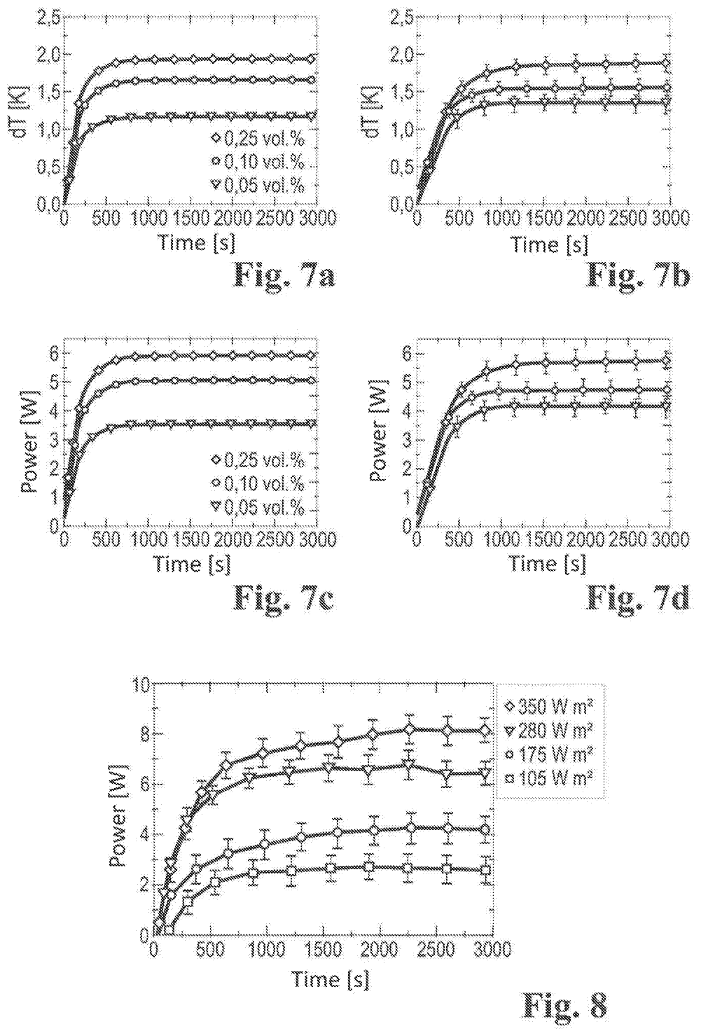

The SPD shading and modulation thereof will now be explained referring to FIGS. 7a-7d.

The operation of the SPD of a building envelope surface element 1 according to the invention under artificial illumination is illustrated in FIG. 7 beginning with the temperature difference ΔT between the inlet at collecting channel 24 and the outlet at collecting channel 25 (shown only in FIG. 2) in a 300×210 mm² fluidic arrangement (SPD) for changing the particle concentrations of the particles 4 in a fluid 3, a flow rate of 50 mL min⁻¹ and a radiation load of 280 W m⁻².

The theoretical and computational data were found to match very closely, which confirms the applicability of the FEM model. Some tests were conducted under controlled conditions in order to ensure that the inlet temperature and ambient temperature remain constant during the entire duration of the experiment. Therefore, the rise in temperature which is recorded at the SPD output is traced back exclusively to irradiation. The energy yield plotted in FIG. 7b makes it possible to quantify the intrinsic yield efficiency at fixed flow rate and radiant flux density, although this changes for a different particle concentration (as can be seen from the following Table 2).

TABLE 2
Yield efficiency for a 300 × 210 mm² window
illuminated by a solar simulator (280 Wm²)
at 20° C. inlet temperature and 50 mL min⁻¹ flow rate.

| c (vol %) | Yield output (W, average) | Intrinsic yield efficiency |
|---|---|---|
| 0.05 | 4.10 | 23.2% |
| 0.10 | 4.75 | 26.9% |
| 0.25 | 5.87 | 33.3% |

The slight deviations between the experimental data (FIG. 7b and FIG. 7d) and the calculation model (FIG. 7a, FIG. 7c) which increase with increasing particle concentration c of particles 4 are essentially to be traced back to an inexact modeling of the optical properties of the particle-charged fluid 3, particularly in that the multiple scattering occurring at the particles 4 is disregarded.

A second set of experiments is compiled in FIG. 8. In this case, the incoming radiant flux density was varied at constant flow velocity of 50 m min⁻¹ and particle concentration of 0.25 vol %. Obviously, the amount of energy yielded increases with increasing radiant flux density. No significant change by a value of (38.5±1.3)% was found for the corresponding intrinsic yield efficiency, i.e., the ratio between the amount of energy transmitted to the system and the amount of energy absorbed through the fluid 3. In other words, there is a linear dependency of the yield output on the illumination density (see FIG. 8) within the examined range of illumination intensity.

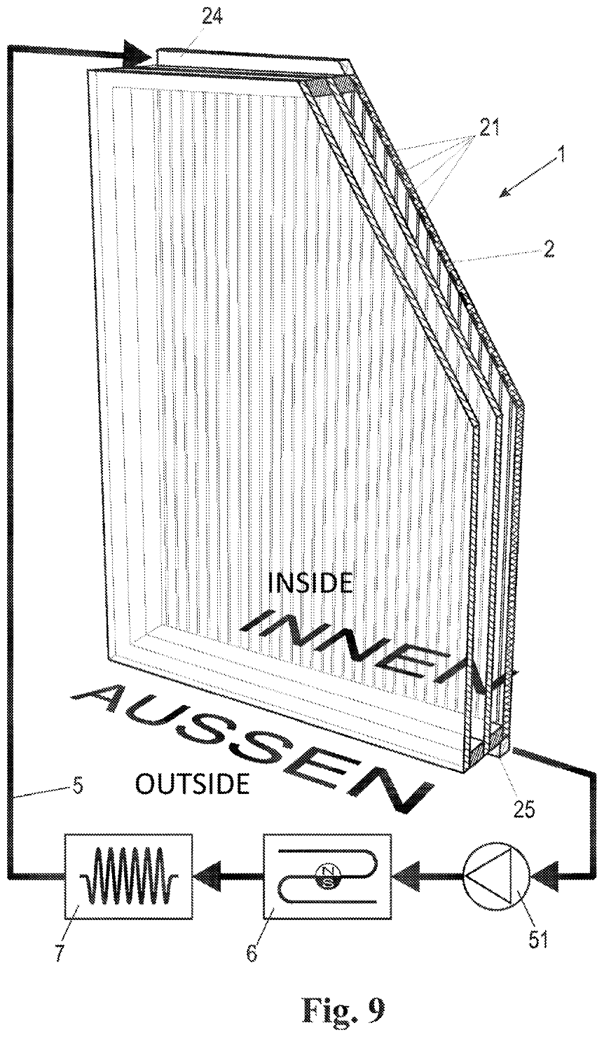

In a preferred application, the building envelope surface element 1 with capillary channels 21 is part of a triple glazing, either externally or internally, as shown in the rear plate position of the triple glazing in FIG. 9. The SPD can be utilized as heat exchanger on the outside position, where the external surroundings are regarded as a reservoir from which heat energy and solar energy are harvested. In the inside position, the SPD acts as a heating element (or cooling element) for the room air.

### First Embodiment Example

### Capillary Glass Element 2

As is shown in FIG. 2B, the production of the capillary glass element is carried out with capillaries having a cross section of approximately 3 mm² and an intercapillary spacing of approximately 3 mm in conventional soda lime glass panes with dimensions of approximately 1000×700 mm² using an inline rolling process which is carried out at the output of a glass melt tank. Bonding was carried out by means of an ethylene vinyl acetate film (evguard, Folienwerk Wolfen GmbH, Germany) which was applied to the interface between the cover plate 23 and the structured place 22 (capillary glass) and hardened. After hardening, the utilized film is optically transparent over the visible spectral region with a refractive index of n_{foil}=1.48. In conformity with previous in-house studies, capillary glass surfaces of 300×210 mm² are taken as basis corresponding to a quantity of 32 capillary channels 21 per SPD. An aluminosilicate glass (AS87, Schott TGS) with adapted thermal expansion coefficient of α_{(20-300° C.)}=8.8·10⁻⁶K⁻¹ is used for the cover plate 23. The thermal conductivity a (25° C.) of the cover plate 23 was 0.96 W m^{31 1} K⁻¹.

### Function Liquid (Fluid 3)

A noncorrosive water/ethylene glycol mixture (43 vol % Antifrogen® L, Clariant Produkte GmbH, Germany) with a low freezing point is used as dispersion medium for the particles 4, in this case magnetite nanoparticles. At 20° C., this fluid 3 has a density of ρ=1.043 g cm⁻³, a dynamic viscosity of 5 mPa s and a refractive index of n_{fluid}=1.382 over the visible spectral region. The specific thermal capacity of the above-specified fluid 3 at 20° C. amounts to 2.5 kJ kg⁻¹ K⁻¹ and its thermal conductivity is 0.21 W mK⁻¹. Spherical iron(III) oxide particles (Fe₃O₄, Sigma Aldrich, USA) with particle sizes in the range of from 50 nm to 100 nm are used for the particle charge with particles 4. The powder should have a purity of 97% based on trace metals with a total density of approximately 5 g cm⁻³. The particles 4 have a specific surface of greater than 60 m² g⁻¹. In order to increase the stability of the suspension of fluid 3, negative charges are induced on the particle surface through the addition of trisodium citrate (Na₃C₆H₅O₇, Sigma-Aldrich, USA) to form an aqueous particle suspension with a volume proportion of particles of 10⁻¹ vol % so that a concentration of [Na₃C₆H₅O₇]=0.1 mol 1⁻¹ results. The suspension is then heated to 90° C. and stirred for 15 minutes before the aqueous portion can be removed. The particles which are dried in this way are then washed in acetone and dispersed again in water. This process may be repeated several times (for example, three times) in order to reduce the concentration of citrate ions in the solution before the final suspension is present in the water/ethylene diol solution. Optical properties of the suspension (clear and charged) are determined on a UV-Vis-IR spectrometer by analyzing the direct and diffusion-spectral transmission and reflection. To this end, suspensions of different particle concentrations are added to silicon dioxide cells for the corresponding background corrections.

### Test Results

The above-mentioned arrangements and liquids (for fluid 3) were combined in prototype SPDs on which heat exchanging characteristics and solar thermal energy absorption were tested. In a typical experiment of this kind, the fluid 3 produced according to the above specifications was equilibrated at a temperature of 22° C. and then pumped with a peristaltic pump 51 at a flow rate of 50 mL min⁻¹ into the system (subsequent experiments were also carried out with varying flow velocity). Using an automated data acquisition routine, the ambient temperature, the inlet temperature and the outlet temperature were recorded as a function of time. In addition, occasional temperature maps were collected with an IR camera. The controlled radiant heat injection was carried out on the cover plate 23 side of the capillary glass element with a solar simulator based on an LED array (Phytolumix UHDS, Futureled GmbH, Germany) in order to replicate the solar spectral radiation over the spectral range from 420 nm to 760 nm. In this range, the above-described capillary glass module is practically completely transparent. The radiant flux was limited to 350 W m⁻² with a lamp collector distance of 250 mm. Accordingly, apart from the Fresnel reflection of the glasses surfaces of plates 22 and 23 and laminate interfaces of the adhesive layer 26, the optical loss is determined solely by the concentration of particles 4 in the fluid 3.

### Calculation Simulation

For further parameterization and optimization of the SPD for the building envelope surface element 1, a three-dimensional finite element model (FEM) was developed on the software platform COMSOL Multiphysics v5.1. This model was used to determine the stationary thermal yield of the present SPD as a function of the concentration of particles 4 in the fluid 3 which stems from earlier in-house FEM model calculations of the capillary glass.

The angle-dependent spectral reflectivity and the extinction were obtained through a transfer matrix process based on Fresnel equations, wherein a static fluid 3 with a determined concentration of particles 4 was assumed. To this end, the optical properties of the suspension using the complex refractive index of iron(III) oxide were specified for the calculations in the following Table 3 as with further parameters.

TABLE 3
Optical and geometric properties of stacks A and B (see
FIG. 5) for simulation of the spectral reflection and absorption
on SPD plane with wavelength λ and imaginary portion of
refractive index k with a particle concentration of 0.05 vol %.

| | Stack A | | Stack B | |
|---|---|---|---|---|
| | Refractive | | Refractive | |
| | index | Thickness | index | Thickness |
| Cover glass | 1.4605 + | 0.7 mm | 1.4605 + | 0.7 mm |
| | 0.0037/λ² | | 0.0037/λ² | |
| EVA adhesive/ | 1.506 | 5.0 μm | 1.382 + | 1.0 mm |
| particle- | | | i · k(λ) | |
| charged fluid | | | | |
| Capillary glass | 1.4605 + | 5.0 mm | 1.4605 + | 4.0 mm |
| | 0.0037/λ² | | 0.0037/λ² | |

### Particle Collector 6

The particle collector suspender construction (particle collector 6) is derived in a similar manner from the computational simulation of the interaction between a collection of magnetite particles (as magnetic particles 4) in a magnetic field. To this end, a field geometry identified with the aid of software makes possible an efficient accumulation of particles 4 and can be converted economically with the current SPD. Assuming a homogeneous distribution of spherical particles 4, drag forces, Brownian forces and magnetic forces were considered.

The final configuration shown in FIG. 3a has an inner pipe diameter of 12 mm, nine meander-shaped pipe elbows or tube elbows with parallel portions. Twenty rod-like permanent magnets 61 are arranged between the latter so as to be switchable in orthogonal and parallel manner and have a residual magnetic flux density of 1.26 T. The particle collector 6 works with a particle diameter of 1 μm (taking into account the potential agglomeration), a particle density of 5000 kg/m⁻³, a viscosity of fluid 3 of 5.144 mPa s, a fluid density of 1.037 g cm⁻³ and particles 4 with a magnetic permeability of 9. Fluid-particle interactions were initially disregarded.

### Second Embodiment Example

A first case of use is directed to a building envelope surface element 1 such as that shown in FIG. 9 as a section from a triple glazing in a building. On a typical winter day, the SPD in the form of the capillary glass element 2 on the outer side of the triple glazing is subject to an outside temperature of −5° C. and an average specific radiation of 100 W m⁻² at its outer side. The capillary glass element 2 with the capillary channels 21 arranged between the structured plate 22 and the cover plate 23 is located on the inside position of a multiple building glazing and is operated with a flow rate of 20 L h⁻¹ m⁻² and a fluid temperature at the inlet of 23° C. in the circuit 5. The fluid 3 according to the schematic diagram in FIG. 9 is circulated from the collecting channel 25 via a pump 51 in the fluid circuit 5 and passes the particle collector 6 which is preferably accommodated inside of a frame element (not shown) of the triple glazing in order to increase, reduce or switch off the magnetic field effect of the electromagnets 63 (shown only schematically in FIG. 9) depending on the required shading. In case radiant energy can be absorbed in the capillary glass element 2 through circulating particles 4, this radiant energy is guided off in a heat exchanger 7 or is left to maintain the inlet temperature of 23° C. in the fluid circuit 5.

Accordingly, the fluidic capillary glass element 2 of the building envelope surface element 1 can provide a comfortable room temperature even when the outside temperature is very cold. Due to the circuit 5, the fluid 3 which carries with it at least a residual quantity of particles 4 through the SPD on a clear winter day will emit the energy absorbed by the SPD. By darkening the fluid 3 by means of a quantity of particles 4 which is additionally “released” by the particle collector 6, a somewhat higher temperature can be achieved, although this can only be carried out at the expense of the daylight that is only allowed to pass to a limited extent.

### Third Embodiment Example

The capillary elements 2 of the building envelope surface elements 1 should be arranged on the inside position of a multiple glazing (as is shown schematically in FIG. 9) and the fluid 3 should flow in at a flow rate of 20 1 h⁻¹ m⁻² and a fluid temperature of 20° C. at the inlet of the capillary glass element 2. The stationary temperatures are determined at various locations of the interior with a clear fluid 3 or particle-charged fluid 3 (absorption coefficient as in the previous example) circulating by means of a pump 51 and utilized to control circuit 5 and particle collector 6 and heat exchanger 7.

In this case, the particle charging with the magnetic particles 4 leads to a significant improvement in the heat insulation of the interior compared to the use of a transparent fluid 3 (4.5° C. decrease in room temperature).

With the SPD configuration presented in the preceding (according to FIG. 2a and FIG. 3a), it was possible to successfully demonstrate that the building envelope surface elements 1 according to the invention, such as glass exterior wall elements, glass roof elements or window elements, are best suited for controllable shading and absorption of light and heat radiation in order to achieve a control without electric area electrodes and with high heat absorption of the particles 4 of fluid 3 and with short switching times for changing transparency and thermal capacity.

### REFERENCE NUMERALS

1 building envelope surface element
2 capillary glass element (of the building envelope surface element)
21 capillary channels
22 structured plate
23 (non-structured) cover plate
24 collecting channel (inlet)
25 collecting channel (outlet)
26 adhesive layer (laminate)
3 fluid (liquid)
4 (magnetic) particles
5 (pumped) fluid circuit
51 pump (of the fluid circuit)
6 particle collector
61 permanent magnet
62 defined pipe portion
63 electromagnet
64 outlet (of the particle collector)
7 heat exchanger (of a heating or cooling system)

1. A building envelope surface element with controllable shading, comprising:
a capillary glass element in which a plurality of parallel capillary channels are formed;
a first collecting channel and a second collecting channel, the parallel capillary channels are connected on one side of the capillary glass element to the first collecting channel (24) and on a second side to the second collecting channel;
a fluid having magnetic particles in the form of a suspension;
a fluid circuit connected to the first collecting channel and the second collecting channel such that a fluid may flow through the capillary channels, the collecting channels, and the fluid circuit
a pump configured to pump the fluid to cause the fluid to flow through the capillary channels via the fluid circuit so as to be circulated by the pump;
a particle collector including pipe portions, the particle collector arranged to be controllable in the fluid circuit outside of the capillary channels in order to concentrate the magnetic particles incorporated in the fluid in the pipe portions of the particle collector by magnetic attraction and to decouple the magnetic particles transiently from the fluid circuit.

2. The building envelope surface element according to claim 1, wherein the particle collector is configured to be activated by switching an orientation of permanent magnets.

3. The building envelope surface element according to claim 1, wherein the particle collector is configured to be activated by switching on electromagnets.

4. The building envelope surface element according to claim 1, wherein the pipe portions of the particle collector are formed two-dimensionally or three-dimensionally as pipe elbows or tube elbows.

5. The building envelope surface element according to claim 4, wherein the defined pipe portions are arranged in a meander-shape.

6. The building envelope surface element according to claim 4, wherein the defined pipe portions are helix-shaped, spiral-shaped or have twofold arrangements formed thereof.

7. The building envelope surface element according to claim 1, wherein the fluid is an aqueous alcohol solution or alkanol solution.

8. The building envelope surface element according claim 1, wherein the fluid is a paraffin oil or a silicone oil.

9. The building envelope surface element according to claim 1, wherein the magnetic particles are made of iron, iron oxide or of dark-colored rare earth metals or rare earth metal oxides.

10. The building envelope surface element according to claim 1, wherein the magnetic particles have an order of magnitude that corresponds to or is greater than one fourth of a wavelength of a radiation incident on the capillary glass element that is to be absorbed.

11. The building envelope surface element according to claim 1, wherein the capillary glass element comprises two plates which are connected to one another, wherein the plurality of parallel capillary channels is formed between opposing surfaces through surface structuring in at least one of the plates and is covered by the other plate.

12. The building envelope surface element according to claim 11, wherein the capillary glass element is assembled from a structured plate and a non-structured cover plate, and the structured plate and cover plate are connected to one another by an overlaminate adhesive layer with an adapted refractive index.

13. A composite window having at least one building envelope surface element according to claim 1, wherein the building envelope surface element forms a portion of the composite window facing a building interior.

14. A building facade system, having at least one building envelope surface element according to claim 1.
